(19) United States
(12) Patent Application Publication
(10) Pub. No.: US 2005/0047747 A1
(43) Pub. Date: Mar. 3, 2005

(54) Optical device, optical-device-assembling apparatus, and method of fixing optical element

(75) Inventor: Tomomi Sano, Kanagawa (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 10/921,333

(22) Filed: Aug. 19, 2004

(30) Foreign Application Priority Data
Aug. 26, 2003 (JP) 2003-301844

(51) Int. Cl. G02B 6/00

(52) U.S. Cl. 385/147

(57) ABSTRACT

An optical device includes a substrate, an optical element provided on the substrate, a metal portion provided on a surface of the substrate, and a metal housing retaining the optical element. The metal housing is fixed to the metal portion with solder. An optical-device-assembling apparatus includes a holding portion for holding a metal housing which retains an optical element, a movable portion for moving the holding portion, and a beam generator for emitting a beam for melting solder with which the metal housing is fixed to a substrate. A method of fixing an optical element on a substrate includes attaching an optical element to a metal housing, forming a metal portion on a surface of the substrate, applying solder on the metal portion, melting the solder and aligning the optical element while the solder is melting, and fixing the metal housing to the metal portion.

### BACKGROUND OF THE INVENTION

1. Field of the Invention

The present invention relates to an optical device including optical elements, such as a lens and a mirror, an apparatus for assembling the optical device, and a method of fixing the optical elements on a substrate.

2. Description of the Background Art

A free-space propagating optical device miniaturized and integrated using the Micro Electro Mechanical System (MEMS) technique is disclosed in OFC2000 ThQ3-1, p244-p246, “Micromachined polarization-state controller and its application to polarization-mode dispersion compensation”.

In this optical device, optical elements which can be fixed on a substrate are limited to elements manufacturable by an MEMS process (semiconductor process). Therefore, birefringence materials, aspheric lenses, half mirrors, etc., cannot be used and versatility in designing the optical device is low.

### SUMMARY OF THE INVENTION

An object of the present invention is to provide an optical device in which various kinds of optical elements can be fixed on a substrate, an apparatus for assembling the optical device, and a method of fixing an optical element on the substrate.

In order to attain the above-described object, the present invention provides an optical device including a substrate and optical elements provided on the substrate. In the optical device, metal portions are provided on a surface of the substrate, and the optical elements are retained by metal housings, which are fixed to the metal portions with solder.

The substrate may have a concave portion and the metal portion may be provided in the concave portion. In this case, the convex portion may have a spherical shape or a cylindrical shape, and a fixing portion having a concave portion of spherical shape or a cylindrical shape may be provided at the bottom of the metal housing such that the concave portion engages with the convex portion.

Alternatively, the substrate may have a convex portion and the metal portion may be provided on the surface of the convex portion. In this case, the convex portion may have a spherical shape or a cylindrical shape and the metal housing may be provided with a fixing portion having a concave portion at the bottom of the metal housing, the concave portion having a spherical shape or a cylindrical shape and engaging with the convex portion.

The substrate may be composed of a material which transmits a beam for melting the solder.

In addition, the present invention provides an apparatus for assembling an optical device including a substrate and an optical element provided on the substrate. This apparatus includes a holding portion for holding a metal housing which retains the optical element, a movable portion for moving the holding portion, and a beam generator for emitting a beam for melting solder with which the metal housing is fixed to the substrate.

The apparatus may be structured such that the substrate can be placed between the beam generator and the holding portion. In addition, the apparatus may further include a light source for emitting light toward the optical element and a light detector for detecting light transmitted through or reflected by the optical element. In addition, the apparatus may further include a camera for monitering an area including the optical element.

In addition, the present invention provides a method of fixing an optical element on a substrate. This method includes the steps of attaching the optical element to a metal housing, forming a metal portion on a surface of the substrate, applying solder on the metal portion, melting the solder and aligning the optical element while the solder is melting, and fixing the metal housing to the metal portion.

Advantages of the present invention will become apparent from the following detailed description, which illustrates the best mode contemplated to carry out the invention. The invention is capable of other and different embodiments, the details of which are capable of modifications in various obvious respects, all without departing from the invention. Accordingly, the accompanying drawing and description are illustrative in nature, not restrictive.

### BRIEF DESCRIPTION OF THE DRAWINGS

The present invention is illustrated by way of example, and not by way of limitation, in the figures of the accompanying drawing in which like reference numerals refer to similar elements.

FIG. 1 is a schematic diagram showing an optical communication system including an optical device according to an embodiment of the present invention;

FIG. 2 is a perspective view of the optical device shown in FIG. 1;

FIG. 3 is a partial sectional view of the optical device shown in FIG. 2 in the state in which an optical element is fixed on a substrate;

FIG. 4 is a schematic diagram of an apparatus for assembling the optical device shown in FIG. 2;

FIGS. 5A to 5C are partial sectional views showing steps of a method of fixing the optical element on the substrate using the optical-device-assembling apparatus shown in FIG. 4;

FIG. 6 is a perspective view of an optical device according to another embodiment of the present invention; and

FIG. 7 is a partial sectional view of an optical device according to yet another embodiment of the present invention.

### DETAILED DESCRIPTION OF THE INVENTION

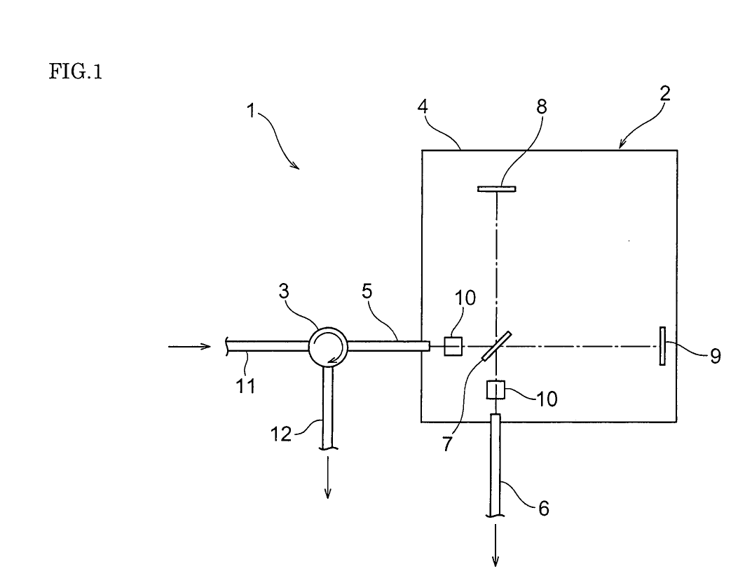

FIG. 1 is a schematic diagram showing an optical communication system including an optical device according to an embodiment of the present invention. In FIG. 1, an optical communication system 1 includes an optical device 2 and an optical circulator 3.

The optical device 2 has a substrate 4, on which optical fibers 5 and 6, a half mirror 7, a first mirror 8, a second mirror 9, and two lenses 10 are mounted. The optical device 2 includes a substrate 4. In addition, optical fibers 5 and 6, a half mirror 7, a first mirror 8, a second mirror 9, and two lenses 10 are mounted on the substrate 4. One of the two lenses 10 is disposed between the optical fiber 5 and the half mirror 7, and the other lens 10 is disposed between the optical fiber 6 and the half mirror 7.

The half mirror 7 partially reflects light emitted from the optical fiber 5 toward the first mirror 8 and partially transmits it toward the second mirror 9. In addition, the half mirror 7 partially reflects light reflected by the first mirror 8 toward the optical fiber 5 and partially transmits it toward the optical fiber 6. In addition, the half mirror 7 partially transmits light reflected by the second mirror 9 toward the optical fiber 5 and partially reflects it toward the optical fiber 6.

The optical circulator 3 is connected to the optical fibers 5, 11, and 12. The optical circulator 3 outputs light received from the optical fiber 11 to the optical fiber 5 and light received from the optical fiber 5 to the optical fiber 12.

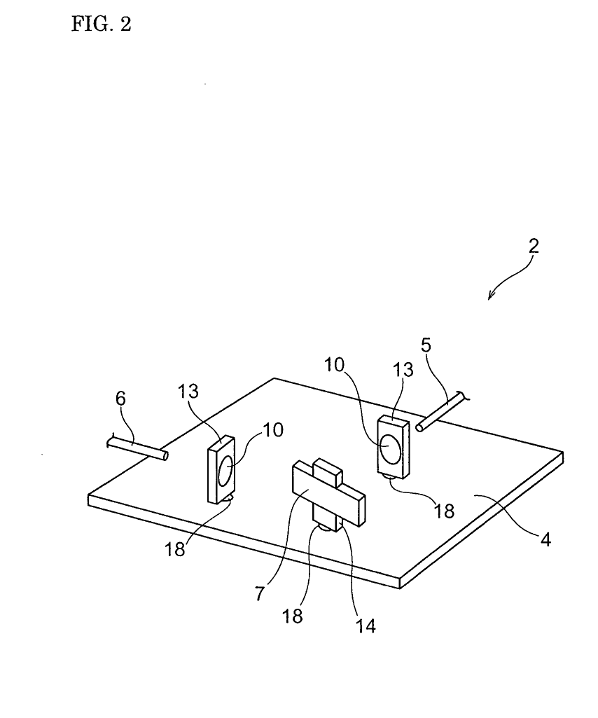

FIG. 2 is a perspective view of the optical device 2 shown in FIG. 1. The mirrors 8 and 9 are omitted in FIG. 2.

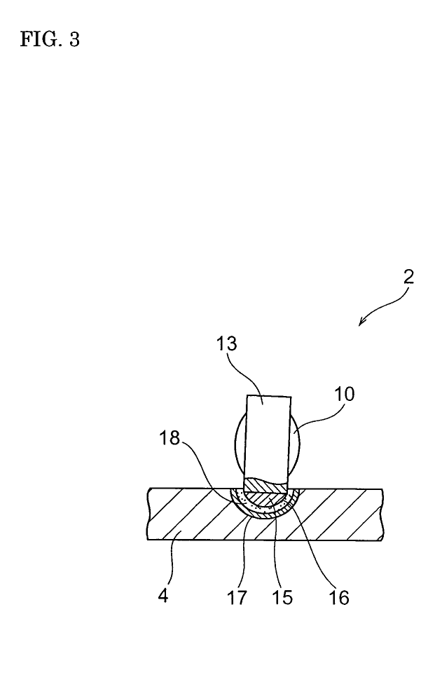

In FIG. 2, the lenses (optical elements) 10 are retained by respective metal housings 13 and the half mirror (optical element) 7 is retained by a metal housing 14. The metal housings 13 and 14 are composed of gold, tin, or the like. As shown in FIG. 3, a fixing portion 15 is provided at the bottom of each metal housing 13 and is fixed to the substrate 4. Each fixing portion 15 preferably has a spherical shape. In addition, although not shown in the figure, the metal housing 14 also has a fixing portion 15 at the bottom thereof.

The substrate 4 on which the lenses 10 and the half mirror 7 are mounted is composed of a material which transmits a beam for melting a solder; for example, made of glass such as quartz glass. The substrate 4 has a plurality of concave portions 16 for receiving the metal housings 13 retaining the lenses 10 and the metal housing 14 retaining the half mirror 7. The concave portions 16, in which the fixing portions 15 of the metal housings 13 and 14 are placed, preferably have a spherical shape corresponding to the shape of the fixing portions 15. The concave portions 16 are formed by, for example, press forming.

A metal portion 17 is formed in each of the concave portions 16. The metal portions 17 are composed of gold, tin, or the like. The metal housings 13 and 14 are fixed to their respective metal portions 17 with solder 18. In this state, the fixing portions 15 of the metal housings 13 and 14 are fixed to their respective metal portions 17 such that the fixing portions 15 are placed in the concave portions 16 formed in the substrate 4. Therefore, the lenses 10 and the half mirror 7 can be strongly and stably fixed to the substrate 4.

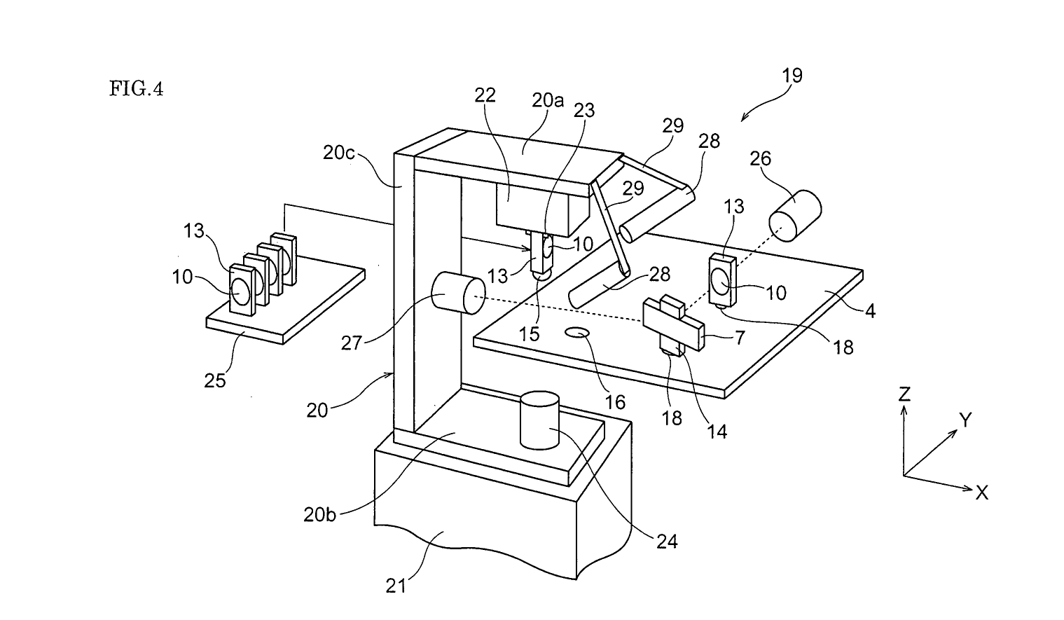

FIG. 4 is a schematic diagram of an apparatus for assembling the optical device 2. In FIG. 4, an optical-device-assembling apparatus 19 includes a U-shaped main body 20 consisting of an upper frame 20a, a lower frame 20b, and a side frame 20c. A driving stage 21 for moving the main body 20 is provided under the main body 20. The driving stage 21 moves the main body 20 in the X-axis direction, the Y-axis direction (both of these directions are horizontal), and the Z-axis (vertical) direction, and rotates the main body 20 around the Z-axis.

A 6-axis adjustment stage (movable portion) 22 is provided under the upper frame 20a of the main body 20. A holding portion 23 for holding a metal housing 13 retaining a lens 10 or a metal housing 14 retaining a half mirror 7 is provided under the 6-axis adjustment stage 22. The 6-axis adjustment stage 22 moves the holding portion 23 in the X-axis direction, the Y-axis direction, and the Z-axis direction, and rotates the holding portion 23 around the X-axis, the Y-axis, and the Z-axis.

A beam heater (beam generator) 24 is disposed on the lower frame 20b of the main body 20 such that the beam heater 24 faces the holding portion 23 across the substrate 4. The beam heater 24 emits a beam for melting the solder 18 applied to the substrate 4. The beam heater 24 may be, for example, a white light source or various kinds of lasers.

In addition, although not shown in the figure, the optical-device-assembling apparatus 19 includes a supporter for supporting the substrate 4 and a supporter for supporting a tray 25 on which elements to be mounted on the substrate 4 are placed.

In addition, the optical-device-assembling apparatus 19 also includes a monitoring light source 26, a monitoring light detector 27, and at least one CCD camera (two CCD cameras 28 are provided in the figure).

The monitoring light source 26 emits light toward an optical element, such as the lens 10, and is supported by a supporter (not shown). The monitoring light detector 27 is attached to the side frame 20c of the main body 20, and receives light emitted from the monitoring light source 26 and transmitted through or reflected by the lens 10, etc. The monitoring light source 26 and the monitoring light detector 27 are used for optical alignment of the lenses 10, etc.

The CCD cameras 28 monitor the area including an optical element, such as a lens 10, which is being fixed on the substrate 4. The CCD cameras 28 may also be used for optical alignment of the lenses 10, etc.

When the optical device 2 including the lenses (optical elements) 10 and the half mirror (optical element) 7 is assembled using the optical-device-assembling apparatus 19, first, the substrate 4 having the concave portions 16 is prepared and the metal portions 17 are formed on the surfaces of the concave portions 16 (see FIG. 3). In addition, the lenses 10 and the half mirror 7 are prepared and are fixed to the metal housings 13 and the metal housing 14, respectively (see FIG. 2). Then, the lenses 10 and the half mirror 7 are placed on the tray 25.

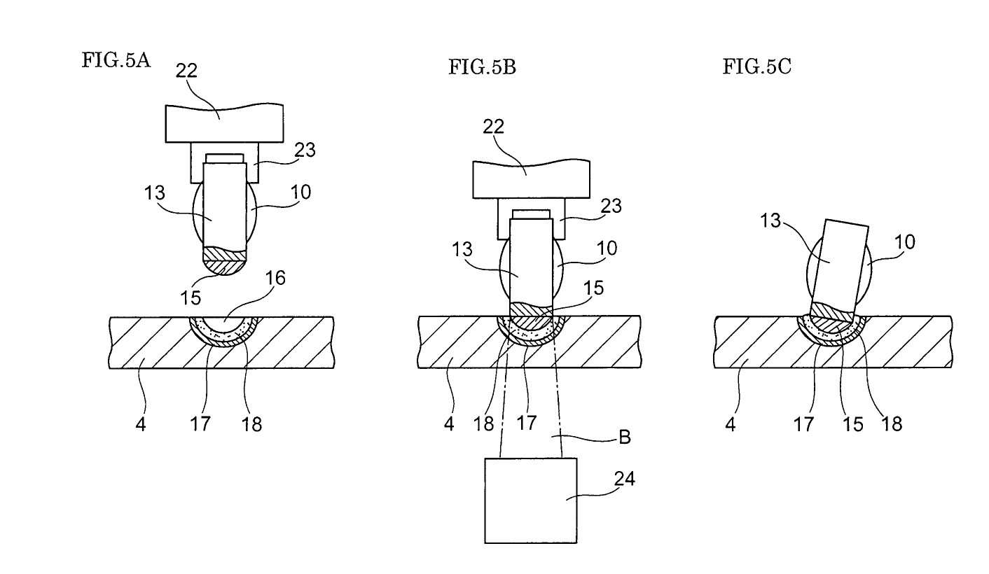

As shown in FIG. 5A, the solder 18 is applied to each of the metal portions 17 formed on the substrate 4. One of the elements placed on the tray 25 (for example, one of the metal housings 13 supporting the lenses 10) is then picked up by the holding portion 23. In this state, the driving stage 21 moves the main body 20 in the X-axis and Y-axis directions and in the direction around the Z-axis so that the element is positioned above the corresponding concave portion 16 of the substrate 4.

Then, as shown in FIG. 5B, the driving stage 21 moves the main body 20 downward and puts the fixing portion 15 of the metal housing 13 in the corresponding concave portion 16 of the substrate 4. Then, in this state, the beam heater 24 emits a beam B toward the concave portion 16. Accordingly, the beam B emitted from the beam heater 24 enters the substrate 4 from the bottom surface thereof, passes through the substrate 4, and reaches the solder 18 to heat and melt the solder 18. Since the beam heater 24 is a heat source having directivity, it can melt the solder 18 efficiently and sufficiently without heating the entire area of the substrate 4.

While the solder 18 is being melted by the beam from the beam heater 24, alignment of the lens 10 is performed by moving the holding portion 23 in the six directions with the 6-axis adjustment stage 22. More specifically, light from the monitoring light source 26 is directed toward the lens 10, and the position of the lens 10 is adjusted while monitoring the quantity of light emitted from the lens 10 with the monitoring light detector 27. Accordingly, without prepareing a light source and a light detector at each time of an assembling of the optical device, an alignment of the optical elements can be easily performed by monitoring the optical characteristics while the solder is melting.

Since the concave portion 16 of the substrate 4 and the fixing portion 15 of the metal housing 13 both have a spherical shape, the metal housing 13 can be easily rotated around a desired axis. Accordingly, the rotational alignment of the lens 10 around the X axis, Y axis, and Z axis can be easily performed.

As shown in FIG. 5C, the beam heater 24 stops emitting the beam B when the alignment of the lens 10 is finished. Accordingly, the solder 18 solidifies and the metal housing 13 is fixed to the metal portion 17 with the solder 18. Then, the holding portion 23 releases the metal housing 13.

When the solder 18 solidifies, it is preferable to monitor the metal housing 13 by means of the CCD cameras 28 in regards to whether or not it is fixed without being moved. The alignment accuracy and fixing accuracy of the lens 10 are then increased.

The other lens 10 and the half mirror 7 are fixed in a similar manner, and the optical device 2 is completed accordingly.

As described above, according to the present embodiment, the optical elements are retained by the metal housings and the metal housings are fixed with the solder to the metal portions formed on the surface of the substrate. Therefore, various kinds of optical elements can be fixed on the substrate, without limiting the optical elements to be adopted. Accordingly, it is possible to reliably fix on the substrate the optical elements, such as birefringence materials, aspheric lenses, half mirrors, etc., which have been considered to be unusable in the manufacturing process using the MEMS technique. Therefore, without a limitation to the kind of optical elements, various kinds of optical elements can be fixed on the substrate to assemble a free-space propagating optical device. Thus, versatility in design is increased.

In addition, the alignment of the optical elements, which is generally considered to be extremely difficult when the MEMS technique is used in the manufacturing process, can be reliably performed by moving the metal housings retaining the optical elements in desired directions while the solder is melting. Accordingly, desired optical characteristics can be obtained when the optical elements are fixed on the substrate, and the reliability of the optical device is increased.

In addition, the substrate is composed of a material which transmits a beam for melting the solder, and the holding portion and the beam generator face each other across the substrate in the optical-device-assembling apparatus. Therefore, the beam enters the substrate from the bottom surface thereof, passes through the substrate, and reaches the metal portion to heat the metal portion, thereby melting the solder. Since the beam enters the substrate from the bottom surface thereof, the beam transmits through only the region under the solder in the substrate. Therefore, the mounting density of the optical elements on the substrate can be increased.

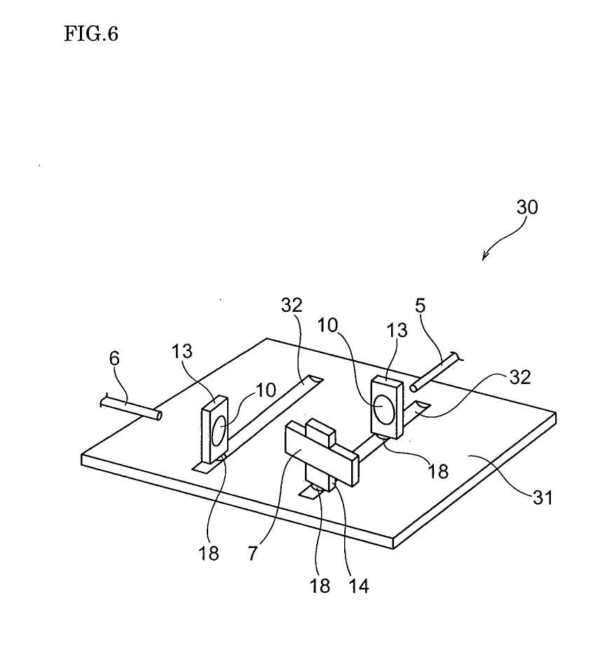

FIG. 6 is a perspective view of an optical device according to another embodiment of the present invention. In FIG. 6, an optical device 30 according to the present embodiment includes a substrate 31, and the substrate 31 has groove-shaped concave portions 32 for receiving a metal housing 13 retaining a lens 10 and a metal housing 14 retaining a half mirror 7. Since the concave portions 32 for receiving the elements are groove-shaped, a plurality of optical elements, such as the lenses 10 and the half mirror 7, can be arranged in a single concave portion 32. The concave portions 32 preferably have a cylindrical shape. In such a case, the rotational alignment of the optical elements placed in a single concave portion 32 can be easily performed.

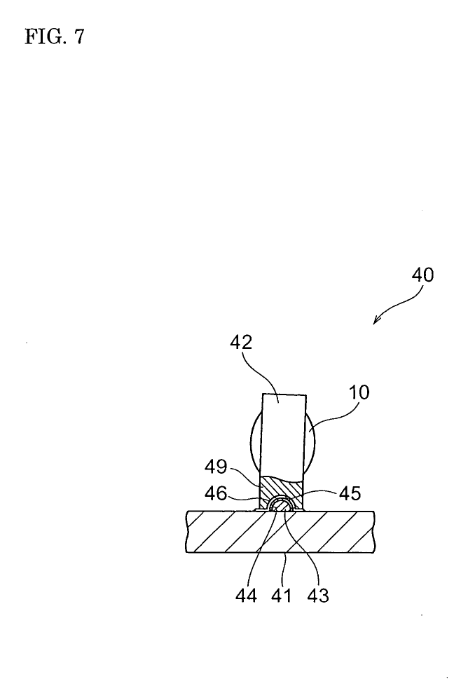

FIG. 7 is a sectional view of an optical device according to another embodiment of the present invention. In FIG. 7, an optical device 40 according to the present embodiment includes a substrate 41, and the substrate 41 has a convex portion 43 on which a metal housing 42 retaining an optical element, such as a lens 10, is placed. The convex portion 43 preferably has a spherical shape so that the rotational alignment of the lens 10 or the like can be easily performed. A metal portion 44 is formed on the convex portion 43.

In addition, a fixing portion 49 having a concave portion 45 is provided at the bottom of the metal housing 42, and the concave portion 45 engages with the convex portion 43. The concave portion 45 preferably has a spherical shape corresponding to the shape of the convex portion 43. The metal housing 42 retaining the lens 10 or the like is fixed to the metal portion 44 with solder 46 such that the convex portion 43 on the substrate 41 is placed in the concave portion 45 of the metal housing 42. In this case, the optical element is stably fixed on the substrate 41, since the metal housing 42 is fixed to the metal portion 44 such that the convex portion 43 on the substrate 41 is placed in the concave portion 45 of the metal housing 42. In addition, since the metal housing 42 retaining the optical element can be easily rotated around a desired axis, the alignment of the optical element can be easily performed.

The present invention is not limited to the above-described embodiments. For example, the material of the substrate is not particularly limited to glass, and silicon, for example, is also suitable since it transmits the beam for melting the solder. In addition, birefringence materials and aspheric lenses may also be used as the optical elements. The optical device according to the present invention may also be applied in a case where metal housings retaining an optical element are fixed on a substrate that has no concave or convex portions. Furthermore, the present invention may of course be applied to optical devices other than a free-space propagating optical device that functions as a Michelson interferometer.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2003-301844 filed on Aug. 26, 2003 including specification, claims, drawings and summary are incorporated herein by reference in its entirety.

1. An optical device comprising:
a substrate;
an optical element provided on the substrate;
a metal portion provided on a surface of the substrate; and
a metal housing retaining the optical element,
wherein the metal housing is fixed to the metal portion with solder.

2. The optical device according to claim 1, wherein the substrate has a concave portion and the metal portion is provided in the concave portion.

3. The optical device according to claim 2, wherein the concave portion has a spherical shape or a cylindrical shape, and
wherein the metal housing is provided with a fixing portion at the bottom of the metal housing, the fixing portion having a spherical shape or a cylindrical shape and being placed in the concave portion.

4. The optical device according to claim 1, wherein the substrate has a convex portion and the metal portion is provided on the surface of the convex portion.

5. The optical device according to claim 4, wherein the convex portion has a spherical shape or a cylindrical shape, and
wherein a fixing portion having a concave portion is provided at the bottom of the metal housing, the concave portion having a spherical shape or a cylindrical shape and engaging with the convex portion.

6. The optical device according to one of claims 1 to 5, wherein the substrate is made of a material that can transmit a beam for melting the solder.

7. An apparatus for assembling an optical device including a substrate and an optical element provided on the substrate, the apparatus comprising:
a holding portion for holding a metal housing which retains the optical element;
a movable portion for moving the holding portion; and
a beam generator for emitting a beam for melting solder with which the metal housing is fixed to the substrate.

8. The apparatus for assembling the optical device according to claim 7, wherein the apparatus is structured such that the substrate is placed between the beam generator and the holding portion.

9. The apparatus for assembling the optical device according to claim 7, further comprising:
a light source for emitting light toward the optical element; and
a light detector for detecting light transmitted through or reflected by the optical element.

10. The apparatus for assembling the optical device according to one of claims 7 to 9, further comprising a camera for monitering an area including the optical element.

11. A method of fixing an optical element on a substrate, the method comprising the steps of:
attaching the optical element to a metal housing for retaining the optical element;
forming a metal portion on a surface of the substrate;
applying solder on the metal portion;
melting the solder and aligning the optical element while the solder is melting; and
fixing the metal housing to the metal portion.
